(19) United States
(12) Patent Application Publication
(10) Pub. No.: US 2005/0154848 A1
(43) Pub. Date: Jul. 14, 2005

(54) Duplication apparatus and method

(76) Inventors: Hiroshi Itoh, Sagamihara-shi (JP); Ryohta Kawase, Tokyo (JP)

Correspondence Address: LIEBERMAN & BRANDSDORFER, LLC, 12221 MCDONALD CHAPEL DRIVE, GAITHERSBURG, MD, 20878, US

(21) Appl. No.: 11/015,524

(22) Filed: Dec. 17, 2004

(30) Foreign Application Priority Data
Dec. 17, 2003 (JP) JP 2003-418892

(51) Int. Cl. G06F 12/16

(52) U.S. Cl. 711/162

(57) ABSTRACT

A technique whereby, when data stored for each block in a storage device are duplicated, a block that is not to be copied is designated to avoid duplication, so that the period required to perform the duplication process for the storage device is reduced. The technique utilizes a duplication apparatus for copying, for each block, data from a source storage device to a destination storage device. The apparatus includes a non-target block identification data acquisition unit to obtain non-target block identification data to identify a block wherein the contents of a non-target file, which is not a copy target, are recorded. In addition, the apparatus includes a target block copying unit to copy to the destination storage device each block, of a plurality of blocks stored in the source storage device, for which block identification data for the block does not match the non-target block identification data.

### BACKGROUND OF THE INVENTION

1. Technical Field

The present invention relates to a duplication apparatus, a duplication method, a duplication program, a block identification data acquisition program, and a recording medium. More specifically, the present invention relates to a duplication apparatus for copying data stored in each block of a source storage device to a destination storage device, and a duplication method, a duplication program, a block identification data acquisition program and a recording medium therefore.

2. Description of the Prior Art

Conventionally, a method for copying, to serve as a backup, the contents of a storage device, such as a hard disk, is employed to prevent the loss, due to disaster, of data recorded on the storage device. Japanese Patent Abstract 8-110840 to Tawara et al. is an example of a method for copying the contents of a storage device whereby updated files on a source storage device are managed, and whereby only updated files are copied to a destination storage device. Japanese Patent Abstract 2002-229830 to Hiraoka discloses a method whereby, to perform a backup for a database, each unit that includes an updated record is copied.

Of these methods, the one used to access a file depends on the storage method used for a file system. However, since the data structure of a file system for storing files in a storage device is complicated, and since many types of file systems are provided, it is difficult to provide backup software that can cope with all the file systems that are currently employed, and that will be employed in a future.

Another method for duplicating the contents of a storage device is one whereby data are copied as blocks, without the data structure of a file system having to be taken into account, and each block is copied. Accordingly, since a simple method can be used to duplicate all the contents of a storage device, regardless of which file system is used, an advantage exists, for example, in that this method can be provided by firmware that uses the control processor for the storage device.

However, according to this method, since all blocks in the storage device are duplicated, the efficiency of a backup is reduced when there are large free spaces in the storage device. To resolve this problem, a method is disclosed whereby information is stored to identify, within each storage area in the storage device, used areas wherein varied data are written and unused areas wherein no valid data are written, and whereby only used areas wherein valid data are written are duplicated. This method disclosed functions effectively for a storage device wherein information is stored for identifying used areas and unused areas. However, for a storage device wherein such information is not stored, data in the all the storage areas must be duplicated.

### SUMMARY OF THE INVENTION

To resolve the above described problems, it is, therefore, one objective of the present invention to provide a duplication apparatus, a duplication method, a duplication program, a block identification data acquisition program and a recording medium.

In one aspect of the invention, a duplication apparatus is provided for copying, for each block, data from a source storage device to a destination storage device. A non-target block identification data acquisition unit is provided to obtain non-target block identification data to identify a block wherein the contents of a non-target file, which is not a copy target, are recorded. In addition, a target block copying unit is provided to copy to the destination storage device each block, of a plurality of blocks stored in the source storage device, for which block identification data for the block does not match the non-target block identification data.

In another aspect of the invention, a duplication apparatus is provided to copy block data from a source storage device to a destination storage device. The apparatus includes a free block acquisition unit to maintain an unused free block, of a plurality of blocks recorded in the source storage device, to record a file in such a state that use of the free block is inhibited for the recording of a file to be copied. In addition, a non-target block identification data acquisition unit is provided to obtain free block identification data to identify the free block, and a target block copying unit is provided to copy to the destination storage device each block, of the plurality of blocks stored in the source storage device, for which the block identification data for the block does not match the free block identification data. Further, a duplication method, a duplication program and a recording medium therefore are provided.

In yet another aspect of the invention, a method is provided to copy a block of data from a source storage device to a destination storage device. Non-target block identification data is obtained of a block having recorded contents of a non-target file stored in the source storage device. Each block in the source storage device is compared with the non-target block identification data. Thereafter, each block stored in the source storage device having block identification data that does not match the non-target identification data is identified and copied to the destination storage device.

In a further aspect of the invention, a method is provided to copy block data from a source storage device to a destination storage device. An unused block of a plurality of blocks being recorded in the source storage device is maintained for recording a file in a state that inhibits use of the free block for recording of a file to be copied. Free block identification data is obtained to identify the free block. Each of a plurality of block being stored in the source storage device are copied to the destination storage device on condition that the block identification data for the block does not match the free block identification data.

In yet a further aspect of the invention, an article is provided in a computer-readable signal-bearing medium. Means in the medium are provided to copy a block of data from a source storage device to a destination storage device. The copy means include means for obtaining non-target block identification data of a block having recorded contents of a non-target file stored in the source storage device. In addition, the copy means includes means to compare each block in the source storage device with the non-target block identification data, and means to identify and copy each block stored in the source storage device having block identification that does not match the non-target identification data to the destination storage device. Further, a recording medium therefore is provided.

In an even further aspect of the invention, an article is provided in a computer-readable signal-bearing medium. Means in the medium are provided to copy block data from a source storage device to a destination storage device. The copy means include means for maintaining an unused free block of a plurality of blocks being recorded in the source storage device to record a file in a state that inhibits use of the free block for recording of a file to be copied.

Other features and advantages of this invention will become apparent from the following detailed description of the presently preferred embodiments of the invention, taken in conjunction with the accompanying drawings.

### BRIEF DESCRIPTION OF THE DRAWINGS

FIG. 1 is a diagram showing the configuration of a file management system according to one embodiment of the present invention, and is suggested for printing on the first page of the issued patent.

FIG. 2 is a flowchart showing the operation of the file management system according to one embodiment of the invention.

FIG. 3 is a diagram showing a recording image duplicated by the file management system according to one embodiment of the invention.

FIG. 4 is a diagram showing the configuration of a file management system according to another embodiment of the invention.

FIG. 5 is a diagram showing an example hardware configuration for a computer according to one embodiment of the invention.

### DESCRIPTION OF THE EMBODIMENTS

According to the present invention, when each block of data stored in a storage device is to be copied, a block that is not to be copied is so designated and is not copied, so that the period required to duplicate the data in the storage device can be reduced.

The present invention will now be described while referring to the preferred embodiment. However, the following embodiment does not limit the invention cited in the claims, and not all the combinations of features explained in the embodiment are always required means for solving problems for the present invention.

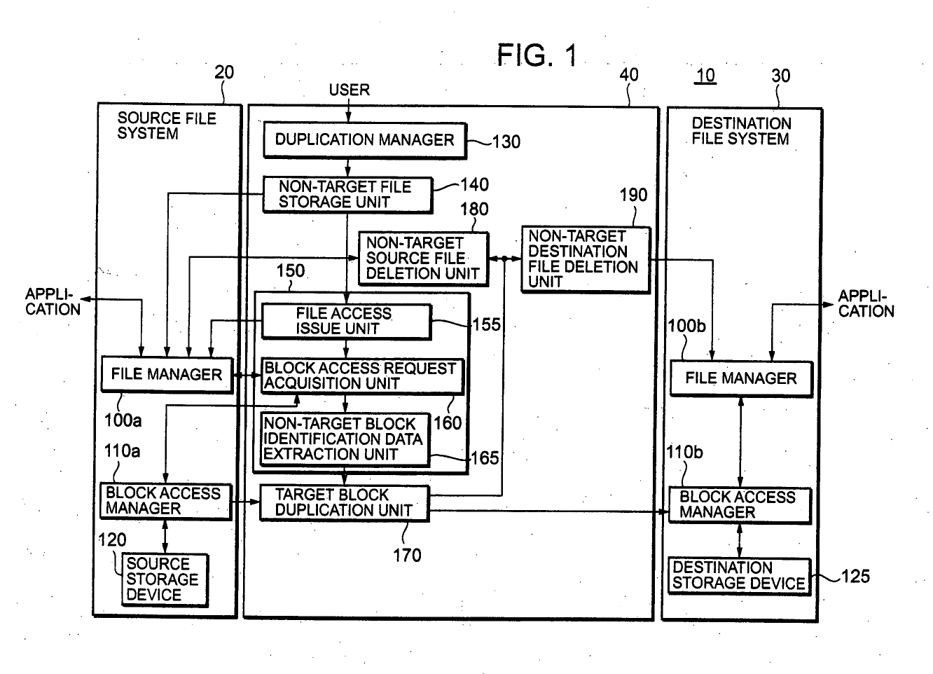

The configuration of a file management system 10 according to the embodiment is shown in FIG. 1. According to a feature of the file management system 10, when data stored in a source storage device 120 are to be copied from each block to a destination storage device 125, first, the file management system 10 designates a block that is not to be copied. Then, blocks other than the designated block not to be copied are copied, so as to reduce the period required for the copying.

The file management system 10 comprises a source file system 20, a destination file system 30 and a duplication apparatus 40. The duplication apparatus 40 of this embodiment copies, to the destination storage device 125, data stored in each block of the source storage device 120. The source file system 20 and the destination file system 30 employ the same recording method.

The source file system 20 includes the source storage device 120, a file manager 100a and a block access manager 110a. The source storage device 120 is a storage device, such as a hard disk, that serves as a source.

For each file, the file manager 100a accesses the source storage device 120 in accordance with a request received from an application program or the duplication apparatus 40. More specifically, when the file manager 10a receives a file access request for accessing the contents of a file stored in the source storage device 120, the file manager 10a, using the recording method of the file system employed in the source storage device 120, obtains management data for the pertinent file by issuing a block access request for accessing blocks wherein the management data is stored. Following this, based on the management data, the file manager 10a designates blocks, in the source storage device 120, wherein the contents of the file are stored, issues a block access request for accessing these blocks, and accesses the contents of the file.

Upon receiving the block access request, the block access manager 110a accesses the block stored in the source storage device 120 that is the access destination of the block access request.

The destination file system 30 includes the destination storage device 125, a file manager 100b and a block access manager 110b. The destination storage device 125 is a storage device that serves as a copying destination. Since the file manager 100b and the block access manager 110b employ the same configurations and have the same functions as the file manager 100a and the block access manager 110a, an explanation will be given only for the ways in which they differ. In this embodiment, the source file system 20 and the destination file system 30 are provided for separate data processing apparatuses, and the file manager 100a and the block access manager 110a access the source storage device 120, while the file manager 100b and the block access manager 110b access the destination storage device 125. However, a single file manager 100 and a single block access manager 110 may access both the source storage device 120 and the destination storage device 125.

The duplication apparatus 40 includes a duplication manager 130, a non-target file storage unit 140, a non-target block identification data acquisition unit 150, a target block duplication unit 170, a non-target source file deletion unit 180, and a non-target destination file deletion unit 190. The duplication manager 130 manages the duplication operation of the duplication apparatus 40, and permits the duplication apparatus 40 to start the duplication operation at a time designated, for example, in accordance with an instruction issued by a user. When the duplication operation is initiated, the non-target file storage unit 140 in the source storage device 120 stores a non-target file that is not to be copied, and transmits to the duplication apparatus 40 information, such as a file name, for identifying the non-target file.

The non-target block identification data acquisition unit 150 obtains non-target block identification data for identifying a block in which to record the contents of a non-target file, one of the files stored in the source storage device 120. The non-target block identification data acquisition unit 150 is provided between the file manager 100a and the block access manager 110a to hook a block access request issued to the block access manager 110a by the file manager 100a. The non-target block identification data acquisition unit 150 includes a file access issue unit 155, a block access request acquisition unit 160, and a non-target block identification data extraction unit 165.

The file access issue unit 155 issues, to the file manager 100a, a file access request for accessing the contents of a non-target file. Upon receiving the file access request issued by the file access issue unit 155, the block access request acquisition unit 160 obtains a non-target block access request, issued by the file manager 100a, for accessing a block wherein the contents of a non-target file are stored. Further, when the block access request acquisition unit 160 hooks the common block access request issued by the file manager 100a, the block access request acquisition unit 160 transfers this block access request to the block access manager 110a, and also transfers to the file manager 100a a response to the block access request that is transmitted by the source storage device 120. Further, the non-target block identification data extraction unit 165 extracts, as non-target block identification data, block identification data for identifying a block stored at the access destination for the non-target block access request.

The target block duplication unit 170 copies to the destination storage device 125 each block, of the multiple blocks stored in the source storage device 120, for which the condition, that the block identification data for the pertinent block not match the non-target block identification data, holds true. That is, the target block duplication unit 170 receives the non-target block identification data from the non-target block identification data acquisition unit 150, and reads from the source storage device 120, through the access manager 110a, blocks for which the identification data do not match the non-target block identification data. Following this, the target block duplication unit 170 writes the thus obtained blocks to the destination storage device 125 through the block access manager 110b. In this case, since the non-target block identification data is information for identifying a block wherein the contents of a non-target file are recorded, the target block duplication unit 170 copies to the destination storage device 125 the individual files in the blocks, including the non-target file, together with management data for these files.

When it is determined that the copying of files to the destination storage device 125 has been completed, the non-target source file deletion unit 180 deletes the non-target file from the source storage device 120. The non-target destination file 190 instructs the file manager 100b to delete the non-target file, and deletes from the destination storage device 125 the management data for the non-target file that was copied by the target block duplication unit 170.

According to the file management system 10 described above, non-target files that are not to be copied are stored in the source storage device 120, and block identification data for blocks wherein the non-target files are recorded is obtained. As a result, non-target blocks that need not be copied can be so designated. And since the duplication apparatus 40 copies to the destination storage device 125 only the blocks in the source storage device 120 that are not non-target blocks, the period required for the copying of blocks can be reduced, when compared with the period required to copy all the blocks.

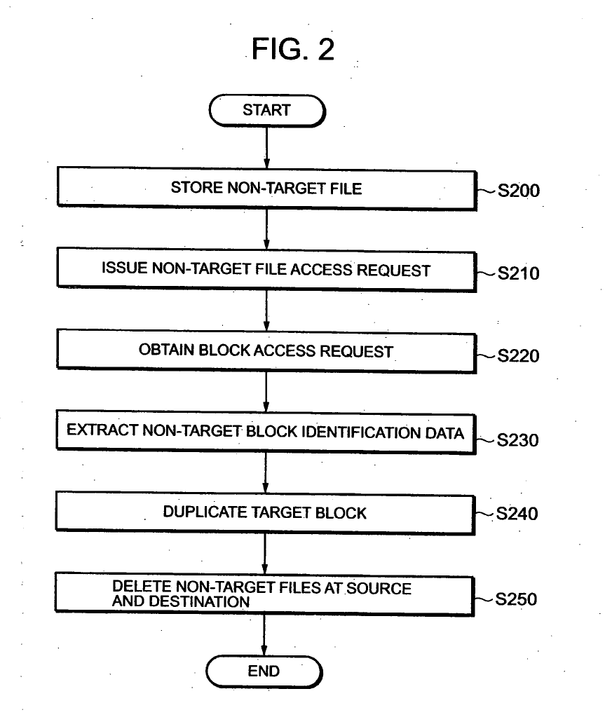

FIG. 2 is a flowchart showing the operation of the file management system according to this embodiment. First, in order to store a non-target file in the source storage device 120, the non-target file storage unit 140 issues a file access request to the file manager 100a (S200). Upon receiving the file access request, the file manager 100a allocates, as an area for recording the non-target file, a free block in the source storage device 120 that is not being used for recording management data or files, and the contents of the non-target file are stored in the allocated block.

The non-target file storage unit 140 in this embodiment also functions as an example free block acquisition unit for this invention. That is, the non-target file storage unit 140 stores, in the source storage device 120, non-target files that are not to be copied, and before a duplication process is initiated, obtains as a block for the recording of the contents of a non-target file a free block that is not being used for the recording of files. Then, the non-target file storage unit 140 maintains the thus obtained free block in a state wherein use of the free block is inhibited for the recording of files to be copied.

Instead of storing a non-target file, which is not to be copied, in the source storage device 120, the non-target file storage unit 140 may transmit to the non-target block identification data acquisition unit 150 a notification that one of the files already stored on the source storage device 120 is a non-target file and is not to be copied.

During this processing, based on the size of the free space in the source storage device 120 before a non-target file is stored, the non-target file storage unit 140 determines the size of a non-target file. More specifically, the non-target file storage unit 140 may determine that the size of the non-target file corresponds to the free storage space. Or, the non-target file storage unit 140 may determine, as the size of the non-target file, a value obtained by subtracting a predesignated margin capacity from the free memory space for the source storage device 120. In this case, even while the duplication processing is ongoing, an application program, for example, can store a file in the source storage device 120.

Further, the non-target file storage unit 140 may store in the source storage device 120 a plurality of non-target files for which the total file size is determined based on the size of the free memory space. In this case, during the duplication processing, the non-target source file deletion unit 180, for example, may periodically monitor the free memory space in the source storage device 120. And when a new file is stored in the source storage device 120, and as a result, the free memory space in the source storage device 120 is a predesignated threshold value or smaller, the non-target source file deletion unit 180 may delete at least one non-target file. Through this processing, while as many as possible non-target blocks are obtained, the non-target files need only be deleted, step by step, when the free memory space in the source storage device 120 is reduced, to increase the free memory space in the source storage device 120. In this case, the target block duplication unit 170 copies, to the destination storage device 125, a block wherein is stored the non-target file deleted by the non-target source file deletion unit 180, and also copies a newly stored file to the destination storage device 125.

Following this, of the files recorded in the source storage device 120, the non-target block identification data acquisition unit 150 obtains a non-target file stored by the non-target file storage unit 140, or non-target block identification data for identifying one or more blocks wherein the contents of a non-target file, which is not to be copied, are stored. At this time, for a non-target file stored by the non-target file storage unit 140, the non-target block identification acquisition unit 150 obtains, as non-target block identification data, free block identification data for identifying a free block allocated for the non-target file.

More specifically, first, the file access issue unit 155 employs data received from the non-target file storage unit 140 to identify a non-target file and to issue to the file manager 100a a file access request for accessing the contents of the non-target file (S210). Upon receiving the file access request, the file manager 100a issues to the block access manager 110a a non-target block access request for accessing a block wherein the contents of the non-target file are to be recorded. The non-target block access request includes block identification data for identifying a block to be accessed, data indicating the type of access, such as reading or writing, and write data requested in a block write request.

Then, the block access request acquisition unit 160 hooks the non-target block access request issued by the file manager 100a (S220). The non-target block identification data extraction unit 165 extracts, as non-target block identification data, block identification data for identifying a block to be accessed, which is designated in the non-target block access request obtained by the block access request acquisition unit 160 (S230).

Sequentially, the target block duplication unit 170 copies to the destination storage device 125 each block, of multiple blocks included in the source storage device 120, for which the condition, that the block identification data for the pertinent block not match the non-target block identification data, holds true (S240). In this case, when the non-target block identification data acquisition unit 150 obtains a plurality of sets of non-target block identification data, the target block duplication unit 170 copies to the destination storage device 125 each block, of multiple blocks included in the source storage device 120, for which the condition, that the block identification data for the pertinent block not match any of the non-target block identification data sets, holds true.

When the non-target source file deletion unit 180 detects that the copying of data to the destination storage device 125 has been completed, the non-target source file deletion unit 180 issues an instruction to the file manager 100a to delete a non-target file stored by the non-target file storage unit 140, so that the non-target file from the source storage device 120 (S250) gets deleted. Further, when the non-target destination file deletion unit 190 detects that the copying of data to the destination storage device 125 has been completed, the non-target destination file deletion unit 190 issues an instruction to the file manager 100b to delete the non-target file for which the management data have been copied to the destination storage device 125, so that the non-target file from the destination storage device 125 (S250) gets deleted. Through this processing, the non-target destination file deletion unit 190 deletes the management data for the non-target file that has been copied to the destination storage device 125, so that an image representing the contents of the destination storage device 125 corresponds to an image representing the contents, except for the non-target files, of the source storage device 120.

As a result of the above processing, the duplication apparatus 40 can copy to the destination storage device 125 blocks, recorded in the source storage device 120, that are to be copied. According to the above described file management system 10, the non-target block identification data acquisition unit 150, which hooks a request transmitted by a file management program to a block access management program, is located between the file manager 100a, which is provided by the file management program in the common operating system, and the block access manager 110a, which is provided by the block access management program, such as a storage block driver. The non-target block identification data acquisition unit 150 transmits a request to the file manager 100a for accessing a non-target file. Upon receiving this request, the file manager 100a issues a block access request to the non-target block identification data acquisition unit 150, which then designates a block wherein the contents of the non-target file are recorded. Therefore, the duplication apparatus 40 permits the file manager 100a to perform a process that depends on the recording method employed by the file system, so that block identification data can be obtained for a block wherein the contents of a non-target file are recorded.

In this embodiment, the block access request acquisition unit 160 may not transfer to the source storage device 120 a non-target block access request issued by the file manager 100a in response to the reception of a non-target file access request from the file access issue unit 155. Further, the block access request acquisition unit 160 may be employed only for the acquisition of non-target block identification data extracted by the non-target block identification data extraction unit 165. In this case, the contents of a non-target file stored in the source storage device 120 need not actually be accessed in response to the file access request issued, in order to obtain the non-target block identification data, by the non-target block identification data acquisition unit 150. Therefore, the number of times the source storage device 120 is accessed during the duplication operation can be reduced, and the data copying operation can be performed faster.

Further, at step S210, the file access issue unit 155 may issue, to the file manager 100a, a file access request for accessing a predesignated required amount of the contents of the non-target file. And, at step S220, when the file manager 100a issues a block access request for a predesignated number of blocks that is determined based on the required amount, the block access request acquisition unit 160 may obtain this block access request as a non-target block access request. That is, for example, the file access issue unit 155 may access the required amount of the contents of the non-target file, and when the file manager 100a issues a block access request for the number of blocks determined in accordance with the required amount/block size, the block access request acquisition unit 160 may designate a file access request that corresponds to the block access request.

Or, the file access issue unit 155 may issue as a file write request, a file access request for writing predesignated required data to a non-target file, and when the file manager 100a issues a block write request for writing the required data, the block access request acquisition unit 160 may obtain the block write access request as a non-target block access request. As a result, under a condition wherein write data designated by the file write request match those designated by the block write request, the block access request acquisition unit 160 can decide that the file access request corresponds to the block access request.

In addition, the non-target source file deletion unit 180 may delete a non-target file from the source storage device 120 after the non-target block identification data have been obtained by the non-target block identification data acquisition unit 150 and before the duplication process is completed. In this case, since the file management system 10 can not perform the duplication process while a free block is being obtained, it is preferable, for example, that an exclusive control process be performed for inhibiting the storage of a new file during the duplication process.

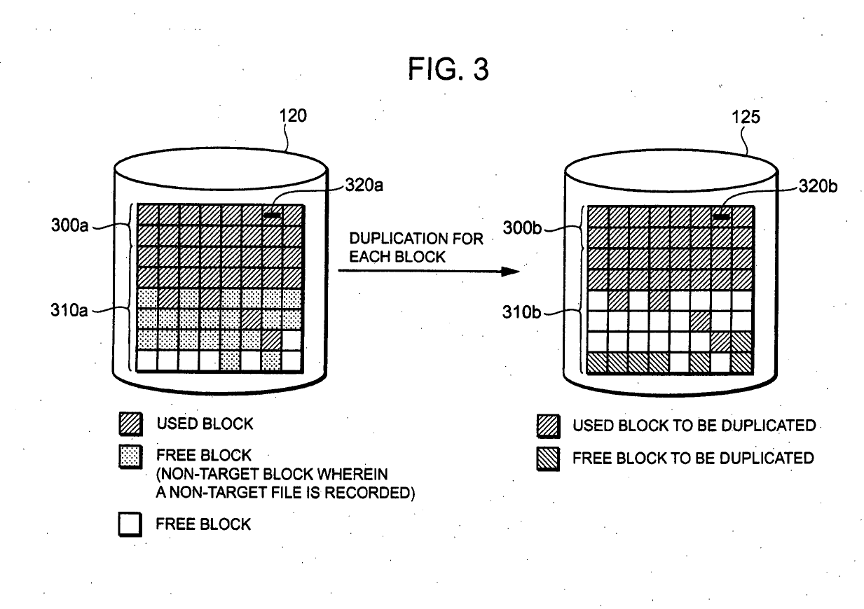

FIG. 3 is a diagram showing an image reproduced by the file management system 10 according to the embodiment. The source storage device 120 includes a file data area 310a consisting of a plurality of blocks wherein the contents of individual files are recorded, and a file management area 300a consisting of a plurality of blocks wherein management data for the recorded files are recorded. Similarly, the destination storage device 125 includes a file data area 310b consisting of a plurality of blocks wherein the contents of individual files are recorded, and a file management area 300b consisting of a plurality of blocks wherein management data for the recorded files are stored.

When the non-target file storage unit 140 stores a non-target file, a free block in the source storage device 120 is allocated for the storage of the non-target file, and management data 320a, including identification data for the block allocated for the non-target file, are recorded in the file management area 300a.

The non-target block identification data acquisition unit 150 employs the file manager 100a to obtain identification data for the non-target block wherein the non-target file is recorded, so that a block that is not to be copied can be designated. To acquire the non-target block identification data, the non-target block identification data acquisition unit 150 may directly obtain the management data 320a from the file manager 100a.

The target block duplication unit 170 copies to the destination storage device 125 all the blocks, other than the non-target block, stored in the source storage device 120. That is, the target block duplication unit 170 copies to the file management area 300b the individual blocks in the file management area 300a, and copies to the file data area 310b all blocks, other than the non-target block, used for file storage, and all free blocks in the file data area 310a. As a result, the management data 320a are copied to the file management area 300b and are used as management data 320b, and a non-target file, for which the contents differ from those of the non-target file stored in the source storage device 120, is present in the destination storage device 125.

The non-target source file deletion unit 180 and the non-target destination file deletion unit 190 respectively delete the non-target files in the source storage device 120 and the destination storage device 125. As a result, the management data 320a and the management data 320b areas are deleted, and images recorded in the source storage device 120 before the non-target file was stored are copied to the destination storage device 125.

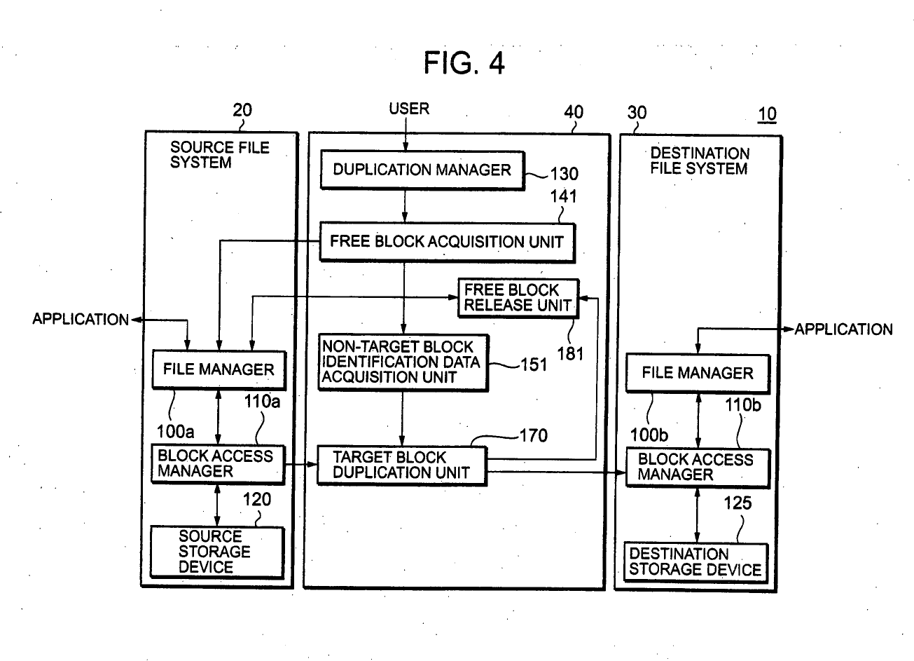

The configuration of the file management system 10 according to a modification of the embodiment is shown in FIG. 4. For the modification, since members denoted by the same reference numerals as members that were explained while referring to FIG. 1 have the same arrangements and functions, an explanation will be given only for the following differences.

From a plurality of blocks stored in the source storage device 120, a free block acquisition unit 141 obtains a free block, one not used for the recording of files, and maintains the free block in a state wherein its use is inhibited for the recording of a file to be copied. That is, through the file manager 100a, the free block acquisition unit 141 removes at least one free block from a free block list maintained for free blocks in the source storage device 120. As a result, the free block acquisition unit 141 does not need to store a non-target file in the source storage device 120, and the file manager 100a can maintain the free block in the state wherein its use is inhibited for the recording of a file. Then, the free block acquisition unit 141 transmits to a non-target block identification data acquisition unit 151 a notification that includes free block identification data for identifying the free block.

Thus, the non-target block identification data acquisition unit 151 obtains, from the free block acquisition unit 141, the free block identification data for identifying the free block. And the target block duplication unit 170 copies, to the destination storage device 125, the individual blocks stored in the source storage device 120 for which the condition, that the block identification data for each block not match the free block identification data, holds true. In this modification, since the free block acquisition unit 141 does not store a non-target file in the source storage device 120, the target block duplication unit 170 can copy to the destination storage device 125, unchanged, a recording image representing the source storage device 120 before the duplication process was begun.

When the copying to the destination storage device 125 is completed, a free block release unit 181 releases the free block that is maintained by the free block acquisition unit 141 in the state wherein its use is inhibited for the recording a file, and enables the use of the free block for recording a file. That is, through the file manager 100a, the free block release unit 181 returns to the free block list, which is maintained for the free blocks in the source storage device 120, the free block that was removed by the free block acquisition unit 141.

According to the file management system 10 of this modification, the process that depends on the source file system 20 must be performed to obtain a free block, while the duplication process can be performed a non-target file not being stored in the source storage device 120.

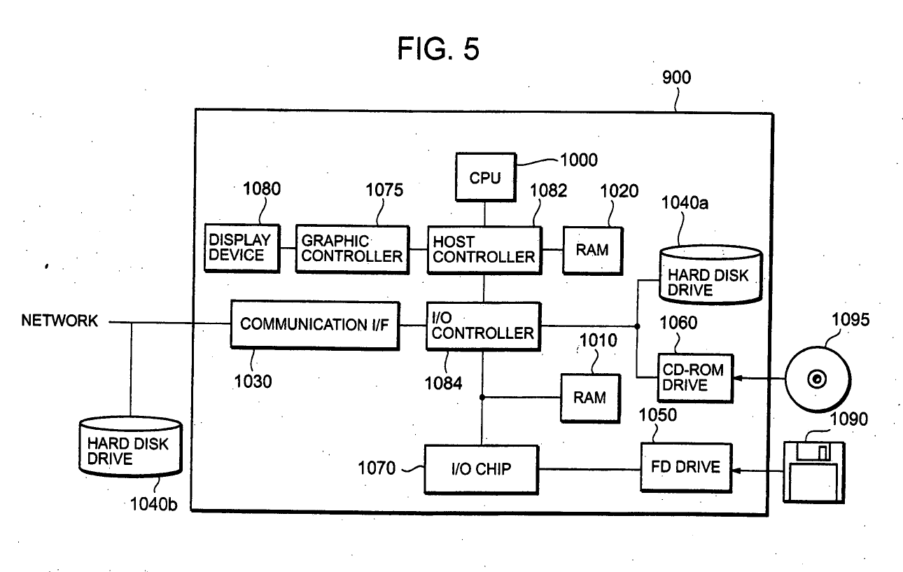

FIG. 5 is a diagram showing an example hardware configuration for a computer 900 according to one embodiment of the invention. The computer 900 for this embodiment comprises: a CPU peripheral section that includes a CPU 1000, a RAM 1020, a graphic controller 1075 and a display device 1080, all of which are interconnected by a host controller 1082, an input/output section that includes a communication interface 1030, a hard disk drive 1040a and a CD-ROM drive 1060, which are connected to the host controller 1082 through an input/output controller 1084, and a legacy input/output section that includes a ROM 1010, a flexible disk drive 1050 and an input/output chip 1070, which are connected to the input/output controller 1084.

The host controller 1082 connects the RAM 1020 to the CPU 1000, which accesses the RAM 1020 at a high transfer rate, and the graphic controller 1075. The CPU 1000, which is operated based on programs stored in the ROM 1010 and the RAM 1020, controls the other, individual sections. The graphic controller 1075 obtains image data generated by the CPU 1000, for example, in a frame buffer provided for the RAM 1020, and displays the image data on the display device 1080. The graphic controller 1075 may internally include a frame buffer for storing image data generated, for example, by the CPU 1000.

The input/output controller 1084 connects the host controller 1082 to the communication interface 1030, which is a comparatively fast input/output device for communicating with another device across a network, the hard disk drive 1040a and the CD-ROM drive 1060. The communication interface 1030 is connected, via the network, to the hard disk drive 1040b that serves as a destination storage device and that is used as a recording device at a backup destination for the hard disk drive 1040a. The hard disk drive 1040a serves as the source storage device 120, and is used to store programs and data employed by the CPU 1000 of the computer 900. The CD-ROM drive 1060 reads a program or data from a CD-ROM 1095 that it transmits, through the RAM 1020, to the hard disk drive 1040a.

The input/output controller 1084 is connected to the ROM 1010 and comparatively slow input/output devices, such as the flexible disk drive 1050 and the input/output chip 1070. The ROM 1010 is used to store a boot program executed by the computer 900 when it is activated, and a program, the execution of which depends on the hardware of the computer 900. The flexible disk drive 1050 reads a program or data from the flexible disk 1090 that it transmits, through the RAM 1020, to the hard disk drive 1040a. The input/output chip 1070 connects various input/output devices through a parallel port, a serial port, a keyboard port and a mouse port, for example.

A program provided, through the RAM 1020, for the hard disk drive 1040a is stored on a recording medium, such as the flexible disk 1090, the CD-ROM drive 1095 or an IC card, and is provided for a user. A program that enables the computer 900 to function as the duplication apparatus 40 is read from the recording medium, is installed, through the communication interface 1030, in the source storage device 120, and is executed by the computer 900.

A duplication program, which is installed in the computer 900 and which permits the computer 900 to serve as the duplication apparatus shown in FIG. 1, comprises: a duplication management module, a non-target file storage module, a non-target block identification data acquisition module, a target block duplication module, a non-target source file deletion module, and a non-target destination file deletion module. The program and these modules act on the CPU 1000 of the computer 900 and permit the computer 900 to serve as the duplication manager 130, the non-target file storage unit 140, the non-target block identification data acquisition unit 150, the target block duplication unit 170, the non-target source file deletion unit 180, and the non-target destination file deletion unit 190.

The non-target block identification data acquisition module may be provided separately as a block identification data acquisition program whereby the computer 900 obtains block identification data, for identifying a block wherein the contents of a file are stored, from a file management program that permits the computer 900 to manage the file stored on the hard disk drive 1040, i.e., from a program that permits the computer 900 to function as the file manager 100. The non-target block identification data acquisition module includes a file access issue module, a block access request acquisition module and a block identification data extraction module. The file access issue module permits the computer 900 to function as the file access issue unit 155, and to issue, to the file management program, a file access request for accessing the contents of the file. The block access request acquisition module permits the computer 900 to function as the block access request acquisition unit 160, and to obtain a block access request that was issued by the computer 900, based on the management program in accordance with the received file access request. The block identification data extraction module permits the computer 900 to extract, as block identification data for a block wherein the contents of a file are stored, block identification data for identifying the access destination of the block access request.

A duplication program, which is installed in the computer 900 and which permits the computer 900 to function as the duplication apparatus 40 shown in FIG. 4, comprises: a duplication management module, a free block acquisition module, a non-target block identification data acquisition module, a target block duplication module, and a free block release module. The program and the modules act on the CPU 1000 of the computer 900 to permit the computer 900 to function as the duplication manager 130, the free block acquisition unit 141, the non-target block identification data acquisition unit 151, the target block duplication unit 170 and the free block release unit 181.

The program or the modules described above may be stored in an external storage medium. This storage medium can be, for example, the flexible disk 1090, the CD-ROM 1095, an optical recording medium such as a DVD or a PD, a magneto-optical recording medium such as an MD, a tape medium, or a semiconductor memory such as an IC card. Further, a storage device, such as a hard disk or RAM, that is provided for a server system that is connected to a special communication network or to the Internet may be employed as a recording medium, and a program may be provided, via the network, for the computer 900.

The present invention has been described by referring to the preferred embodiment. However, the technical scope of the invention is not limited to the embodiment, and it will be obvious to one having ordinary skill in the art that the embodiment of the invention can be variously modified or improved. From the description of the claims of the present invention, it is apparent that within the technical scope of the invention, modification of the embodiment and an improved embodiment can be included.

According to the above described embodiment, a duplication apparatus, a duplication method, a duplication program, a block identification data acquisition program and a recording medium therefor. It will be appreciated that although specific embodiments of the invention have been described herein for the purposes of illustration, various modifications may be made without departing from the spirit and scope of the invention. Accordingly, the scope of protection of this invention is limited only by the following claims and their equivalents.

1. A duplication apparatus to copy a block of data from a source storage device to a destination storage device, comprising:
a non-target block identification data acquisition unit adapted to obtain non-target block identification data of a block having recorded contents of a non-target file; and
a target block copy unit adapted to copy to the destination storage device each block stored in the source storage device having block identification data that does not match the non-target block identification data.

2. The apparatus of claim 1, further comprising:
a non-target file storage unit adapted to store the non-target file in the source storage device, wherein the non-target block identification data acquisition unit obtains the non-target block identification data stored by the non-target file storage unit to identify a block wherein the contents of the non-target file are recorded.

3. The apparatus of claim 2, wherein the non-target file storage unit determines the size of the non-target file based on free memory space in the source storage device.

4. The apparatus of claim 3, wherein the non-target file storage unit designates a size of the non-target file based upon a value obtained by subtracting a pre-designated margin memory from the free memory space in the source storage device.

5. The apparatus of claim 3, wherein the non-target file storage unit stores a plurality of non-target files in the source storage device;
wherein a non-target source file deletion unit is further provided to delete at least one of the non-target files from the source storage device when a new file has been stored in the source storage device and when the free memory space in the source storage device wherein the plurality of non-target files are stored is a predesignated threshold value or smaller; and
wherein the target block duplication unit is adapted to duplicate a block wherein the non-target file deleted by the non-target source file deletion unit was stored in the destination storage device.

6. The apparatus of claim 1, further comprising:
a non-target source file deletion unit adapted to delete the non-target file from the source storage device when the completion of the duplication performed for the destination storage device is detected.

7. The apparatus of claim 1, wherein for each file stored in the source storage device, the target block duplication unit duplicates in the destination storage device management data that includes the file name of the file and block identification data for a block wherein the contents of the file are recorded; and
wherein a non-target destination file deletion unit is further provided to delete from the destination storage device the management data for the non-target file that is duplicated by the target block duplication unit.

8. The apparatus of claim 1, wherein the non-target block identification acquisition unit obtains a plurality of sets of non-target block identification data to identify a plurality of blocks wherein the contents of the non-target file are stored; and
wherein the target block duplication unit duplicates in the destination storage device each block included in the source storage device for which a condition, that block identification data for the block not match any of the plurality of sets of non-target block identification data, holds true.

9. The apparatus of claim 1, wherein the non-target block identification data acquisition unit further comprises:
a file access issue unit adapted to issue a file access request to access contents of the non-target file to a file manager that accesses the source storage device for each file;
a block access request acquisition unit adapted to obtain a non-target block access request issued by the file manager in order to access a block wherein contents of the non-target file are recorded in response to receipt of the file access request; and
a non-target block identification data extraction unit adapted to extract block identification data to identify a block at an access destination for the non-target block access request as the non-target block identification data.

10. The apparatus of claim 9, wherein the file access issue unit issues to the file manager the file access request to access a required, predesignated amount of contents of the non-target file; and
wherein, when the file manager has issued a block access request for a predesignated number of blocks that is determined based on the required, predesignated amount, the block access request acquisition unit obtains the block access request as the non-target block access request.

11. The apparatus of claim 9, wherein the file access issue unit issues a file write request to write required, predesignated data to the non-target file; and
wherein, when the file manager has issued the block write request to write the required, predesignated data, the block access request acquisition unit obtains, as the non-target block access request, a block write request.

12. An apparatus to copy block data from a source storage device to a destination storage device, comprising:
a free block acquisition unit adapted to maintain an unused free block of a plurality of blocks being recorded in the source storage device and to record a file in such a state that use of the free block is inhibited for the recording of a file to be copied;
a non-target block identification data acquisition unit adapted to obtain free block identification data to identify the free block; and
a target block copy unit adapted to copy to the destination storage device each block, each of the plurality of the blocks being stored in the source storage device, on condition that the block identification data for the block does not match the free block identification data.

13. The apparatus of claim 12, wherein the free block acquisition unit stores a non-target file that is not to be copied in the source storage device, and obtains the free block as a block wherein the contents of the non-target file are to be recorded, so that the free block is maintained in a state wherein the use of the free block is inhibited for recording a file to be copied; and
wherein the non-target block identification data acquisition unit obtains the non-target block identification data to identify the block wherein the contents of the non-target block are recorded.

14. A method for copying a block of data from a source storage device to a destination storage device comprising:
obtaining non-target block identification data of a block having recorded contents of a non-target file stored in the source storage device; and
copying to the destination storage device each block stored in the source storage device having block identification data that does not match the non-target identification data.

15. The method of claim 14, further comprising storing the non-target file in the source storage device, wherein a non-target block identification data acquisition unit obtains the non-target block identification stored by the non-target file storage unit to identify a block wherein the contents of the non-target file are recorded.

16. The method of claim 15, further comprising the non-target file storage unit determining the size of the non-target file based on free memory space in the source storage device.

17. The method of claim 16, further comprising the non-target file storage unit designating a size of the non-target file based upon a value obtained by subtracting a pre-designated margin memory from the free memory space in the source storage device.

18. The method of claim 16, further comprising:
storing a plurality of non-target files in the source storage device;
deleting at least one of the non-target files from the source storage device when a new file has been stored in the source storage device and when the free memory space in the source storage device attains a a value selected from a group consisting of: a predesignated threshold value, and a value smaller than a predesignated threshold value; and
duplicating a block in the destination storage device having stored the deleted non-target file.

19. The method of claim 14, further comprising deleting the non-target file from the source storage device in response to detection of completion of duplication for the destination storage device.

20. The method of claim 14, further comprising duplicating device management data for a block having contents of a record file in the destination storage device, and deleting management data for the duplicated non-target file from the destination storage device.

21. The method of claim 14, wherein the step of obtaining non-target block identification data includes obtaining a plurality of sets of non-target block identification data to identify a plurality of blocks wherein contents of the non-target file are stored; and wherein the step for identifying and copying each block stored in the source storage device to the destination device includes duplicating each block in the destination storage device for which block identification data for the block does not match any of a plurality of sets of non-target block identification data.

22. The method of claim 14, wherein the step for obtaining non-target block identification data includes:
issuing a file access request to access contents of the non-target file to a file manager that accesses the source storage device for each file;
said file manager issuing a non-target block access request to access a block wherein the contents of the non-target file are recorded in response to receipt of the file access request; and
extracting block identification data for identifying a block at an access destination.

23. The method of claim 22, wherein the step of issuing a file access request to access contents of the non-target file to a file manager that accesses the source storage device for each file includes issuing the file access request to the file manager to access a required and predesignated amount of contents of the non-target file; and wherein the step of issuing a non-target block access request to access a block wherein the contents of the non-target file are recorded in response to receipt of the file access request includes a block write request.

24. A method for copying block data from a source storage device to a destination storage device, comprising:
maintaining an unused free block of a plurality of blocks being recorded in the source storage device for recording a file in a state that inhibits use of the free block for recording of a file to be copied;
obtaining free block identification data to identify the free block; and
copying to the destination storage device each of a plurality of blocks being stored in the source storage device on condition that the block identification data for the block does not match said free block identification data.

25. The method of claim 24, wherein the step of maintaining an unused free block of a plurality of block being recorded in the source storage device for recording a file in a state that inhibits use of the free block for recording of a file to be copied includes storing a non-target file that is not to be copied in the source storage device, and obtaining the free block as a block wherein the contents of the non-target file are to be recorded, and wherein the step of obtaining free block identification includes obtaining non-target block identification data to identify the block wherein the contents of the non-target block are recorded.

26. An article comprising:
a computer-readable signal-bearing medium;
means in the medium for copying a block of data from a source storage device to a destination storage device comprising:
said copying means comprising:
means for obtaining non-target block identification data of a block having recorded contents of a non-target file stored in the source storage device;
means for identifying and copying to the destination storage device each block stored in the source storage device having block identification data that does not match the non-target identification data.

27. The article of claim 26, wherein said medium is selected from the group consisting of: a recordable data storage medium, and a modulated carrier signal.

28. An article comprising:
a computer-readable signal-bearing medium;
means in the medium for copying block data from a source storage device to a destination storage device, said means comprising:
means for maintaining an unused free block of a plurality of blocks being recorded in the source storage device for recording a file in a state that inhibits use of the free block for recording of a file to be copied;
means for obtaining free block identification data to identify the free block; and
means for copying to the destination storage device each of a plurality of blocks being stored in the source storage device on condition that the block identification data for the block does not match said free block identification data.

29. The article of claim 36, wherein said medium is selected from a group consisting of: a recordable data storage medium, and a modulated carrier signal.
